(19) United States
(12) Patent Application Publication
(10) Pub. No.: US 2025/0161991 A1
(43) Pub. Date: May 22, 2025

(54) Article Sorting Facility

(71) Applicant: Daifuku Co., Ltd., Osaka-shi (JP)

(72) Inventors: Akira Takeuchi, Hinocho (JP); Toru Konagaya, Hinocho (JP); Yuto Hatanaka, Hinocho (JP)

(21) Appl. No.: 18/948,605

(22) Filed: Nov. 15, 2024

(30) Foreign Application Priority Data
Nov. 16, 2023 (JP) 2023-195214

(51) Int. Cl. B07C 3/08; B65G 47/94

(52) U.S. Cl. CPC B07C 3/08; B65G 47/94

(57) ABSTRACT

An article sorting facility includes an auxiliary Y-direction path in at least one of a plurality of Y-direction inter-path areas each between a pair of Y-direction paths adjacent to each other in the X-direction. The auxiliary Y-direction path is a path on which a plurality of transport vehicles travel in the Y-direction. The auxiliary Y-direction path branches from at least one of the pair of Y-direction paths adjacent to each other in the X-direction.

### CROSS-REFERENCE TO RELATED APPLICATION

This application claims priority to Japanese Patent Application No. 2023-195214 filed Nov. 16, 2023, the disclosure of which is hereby incorporated by reference in its entirety.

### BACKGROUND OF THE INVENTION

### Field of the Invention

The present invention relates to an article sorting facility in which multiple transport vehicles transport articles.

### Description of Related Art

Known article sorting facilities in which multiple transport vehicles transport articles are used in, for example, distribution warehouses. For example, Japanese Unexamined Patent Application Publication No. 2020-100482 (JP No. 2020-100482 1) describes an article sorting facility in which multiple transport vehicles (V) transport articles from multiple supply units (90) to multiple receivers (80).

In the article sorting facility described in JP No. 2020-100482, multiple transport vehicles may have their paths intersecting each other when traveling from the supply units to the receivers. However, multiple transport vehicles cannot pass the same intersection at the same time. In this case, one transport vehicle is allowed to travel, whereas another transport vehicle waits. Thus, multiple transport vehicles waiting at positions or on paths that are likely to cause congestion can lower the transport efficiency.

### SUMMARY OF THE INVENTION

One or more aspects are directed to an article sorting facility with transport vehicles for which the article transport efficiency is less likely to decrease.

An article sorting facility according to an aspect of the disclosure is an article sorting facility in which a plurality of transport vehicles travel on a floor and transport articles to sort the articles. The article sorting facility includes a plurality of supply units that supply the articles to the plurality of transport vehicles and a plurality of receivers that receive the articles from the plurality of transport vehicles. The floor includes a connection area, a plurality of entrances, and a plurality of exits. The connection area extends in a Y-direction along the floor and in an X-direction perpendicular to the Y-direction along the floor. The plurality of entrances are arranged in the X-direction on a first side in the Y-direction of the connection area and are locations through which the plurality of transport vehicles supplied with the articles at the plurality of supply units enter the connection area. The plurality of exits are arranged in the X-direction on a second side in the Y-direction of the connection area and are locations through which the plurality of transport vehicles traveling toward the plurality of receivers exit the connection area. The connection area includes a plurality of Y-direction paths and a plurality of X-direction paths. The plurality of Y-direction paths are arranged in the X-direction, are as many as the plurality of entrances, and are paths on which the plurality of transport vehicles travel in the Y-direction. The plurality of X-direction paths are arranged in the Y-direction and are paths on which the plurality of transport vehicles travel in the X-direction. The floor includes an auxiliary Y-direction path in at least one of a plurality of Y-direction inter-path areas each between a pair of Y-direction paths, among the plurality of Y-direction paths, adjacent to each other in the X-direction. The auxiliary Y-direction path is a path on which the plurality of transport vehicles travel in the Y-direction. The auxiliary Y-direction path branches from at least one of the pair of Y-direction paths adjacent to each other in the X-direction.

In this structure, some of the transport vehicles that travel on at least one Y-direction path travel on the auxiliary Y-direction path. This reduces the number of transport vehicles that travel on the Y-direction path. The path on which a transport vehicle traveling from the Y-direction path travels in the X-direction before merging into the auxiliary Y-direction path can serve as a standby position at which the transport vehicle waits before merging into the auxiliary Y-direction path. This reduces congestion of transport vehicles traveling in the Y-direction, thus reducing the likelihood that the article transport efficiency of the transport vehicles decreases.

### BRIEF DESCRIPTION OF THE DRAWINGS

FIG. 1 is a top view of an article sorting facility according to a first embodiment.

FIG. 2 is a front view of a receiving area in FIG. 1.

FIG. 3 is a control block diagram of the article sorting facility in FIG. 1.

FIG. 4 is a diagram of a first layer in the article sorting facility in FIG. 1.

FIG. 5 is a diagram of a second layer in the article sorting facility in FIG. 1.

FIG. 6 is a diagram describing corresponding exiting paths in FIG. 4.

FIG. 7 is a diagram of a first layer in an article sorting facility according to a second embodiment.

FIG. 8 is a top view of an article sorting facility according to a third embodiment.

FIG. 9 is a front view of a receiving area in FIG. 8.

FIG. 10 is a top view of an article sorting facility according to a fourth embodiment.

### DESCRIPTION OF THE INVENTION

### First Embodiment

An article sorting facility 10 according to a first embodiment will be described below with reference to the drawings.

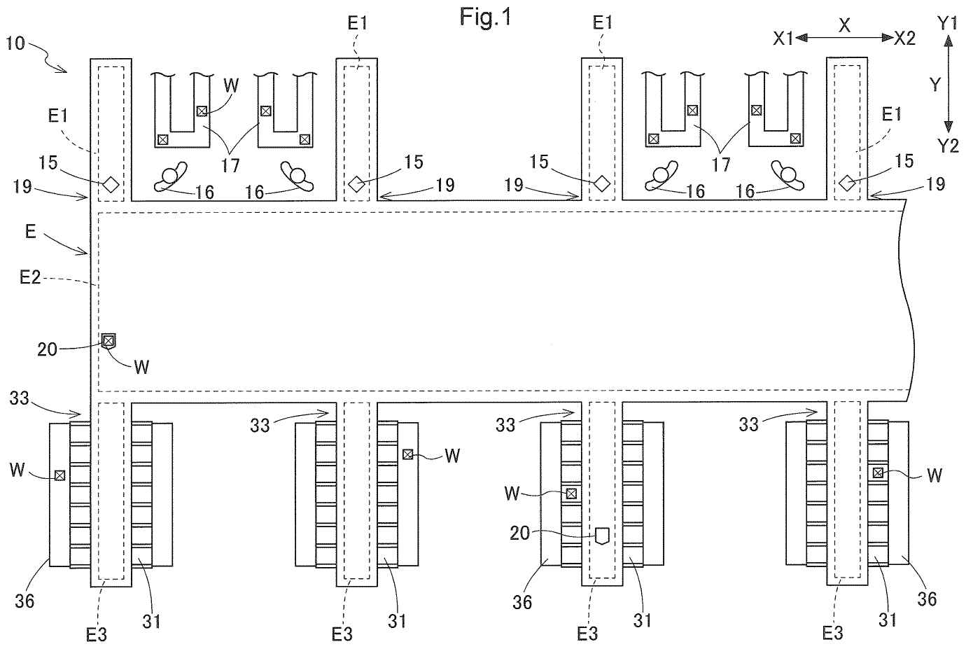

FIG. 1 is a top view of the article sorting facility 10 in which multiple transport vehicles 20 transport articles W. In the article sorting facility 10 according to the present embodiment, the multiple transport vehicles 20 travel on a floor E and transport the articles W to sort the articles W. In the present embodiment, the article sorting facility 10 includes the floor E, supply units 15, and receivers 31. The supply units 15 supply the articles W to the respective transport vehicles 20. The receivers 31 receive the articles W from the respective transport vehicles 20. In the present embodiment, the article sorting facility 10 includes the multiple transport vehicles 20, the floor E, the multiple supply units 15, and the multiple receivers 31.

In the present embodiment, an operating entity 16 transfers articles W to the transport vehicles 20 at each supply unit 15. The operating entity herein refers to, for example, an operator, an operating device, or both. The operating entity 16 transfers the articles W from a supply transporter 17 to the transport vehicles 20. The supply transporter 17 transports the articles W from an automated warehouse (not shown). Examples of the supply transporter 17 include a belt conveyor, a crane, and a robotic arm. In some embodiments, the supply units 15 may each include a mount to which the articles W are supplied by the corresponding supply transporter 17. The transport vehicles 20 then receive the articles W supplied to the mount.

A specific direction along the floor E is herein referred to as the Y-direction. A direction along the floor E and perpendicular to the Y-direction is referred to as the X-direction. One side in the Y-direction is referred to as a first side Y1 in the Y-direction, and the other side in the Y-direction is referred to as a second side Y2 in the Y-direction. One side in the X-direction is referred to as a first side X1 in the X-direction, and the other side in the X-direction is referred to as a second side X2 in the X-direction. The vertical direction is referred to as the Z-direction. Examples of the floor E include a travel surface on which vehicles travel and a floor in buildings, ships, and other facilities. In the present embodiment, the floor E is a travel surface on an indoor platform.

The floor E includes a connection area E2 extending in the Y-direction and the X-direction. The floor E includes multiple entrances 19 arranged in the X-direction on the first side Y1 in the Y-direction of the connection area E2. The entrances 19 are locations through which the transport vehicles 20 supplied with the respective articles W at the supply units 15 enter the connection area E2. The floor E includes multiple exits 33 arranged in the X-direction on the second side Y2 in the Y-direction of the connection area E2. The multiple exits 33 are locations through which the transport vehicles 20 traveling toward the receivers 31 exit the connection area E2.

In the present embodiment, the floor E has supply areas E1 with the supply units 15, and receiving areas E3 with the receivers 31. The supply areas E1 are arranged on the first side Y1 in the Y-direction relative to the receiving areas E3. In the illustrated example, the multiple supply areas E1 are arranged and include the respective supply units 15. The multiple supply areas E1 are arranged in the X-direction. The multiple receiving areas E3 are arranged in the X-direction. The multiple receiving areas E3 are arranged and include the respective receivers 31.

In the present embodiment, the connection area E2 connects the receiving areas E3 and the supply areas E1. In the illustrated example, the connection area E2 connects the multiple supply areas E1 to the respective receiving areas E3. The connection area E2 connects the supply areas E1 to the receiving areas E3 to allow the transport vehicles 20 to travel between the areas.

The supply areas E1, the connection area E2, and the receiving areas E3 on the floor E may be physically divided areas or virtual areas (virtually defined areas) on the floor E. In the present embodiment, the boundaries between the supply areas E1 and the connection area E2 are virtual boundaries defined on the floor E. In the present embodiment, each receiving area E3 has its two ends in the X-direction that are the outer edges of the floor E.

In the present embodiment, the entrances 19 in the respective supply areas E1 are arranged in the X-direction on the floor E. The multiple supply areas E1 each include a single entrance 19.

In the present embodiment, the exits 33 in the respective receiving areas E3 are arranged in the X-direction on the floor E. The multiple receiving areas E3 each include a single exit 33.

In the present embodiment, the transport vehicles 20 return to the respective supply areas E1 through a second layer F2 (described later). However, the entrances 19 may also serve as exits from the connection area E2 to the supply areas E1. The exits 33 may also serve as entrances from the receiving areas E3 to the connection area E2.

In the present embodiment, the multiple supply areas E1 are connected to one another with the connection area E2. The multiple supply areas E1 each include an area in the form of an aisle extending in the Y-direction. In the illustrated example, the supply areas E1 are areas in the form of aisles extending in the Y-direction.

In the present embodiment, the multiple receiving areas E3 are connected to one another with the connection area E2. The multiple receiving areas E3 each include an area in the form of an aisle extending in the Y-direction. In the illustrated example, the receiving areas E3 are areas in the form of aisles extending in the Y-direction. The multiple receivers 31 are arranged in the Y-direction along the respective receiving areas E3.

In the illustrated example, the entrances 19 are aligned with the respective exits 33 as viewed in the Y-direction. In other words, each entrance 19 is at the same position in the X-direction with the corresponding exit 33. The connection area E2 connects the entrances 19 to the exits 33 to allow the transport vehicles 20 to travel between them.

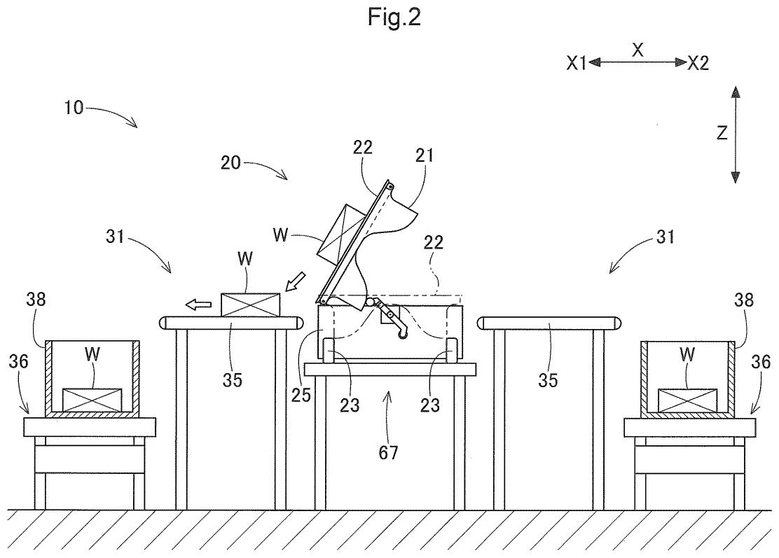

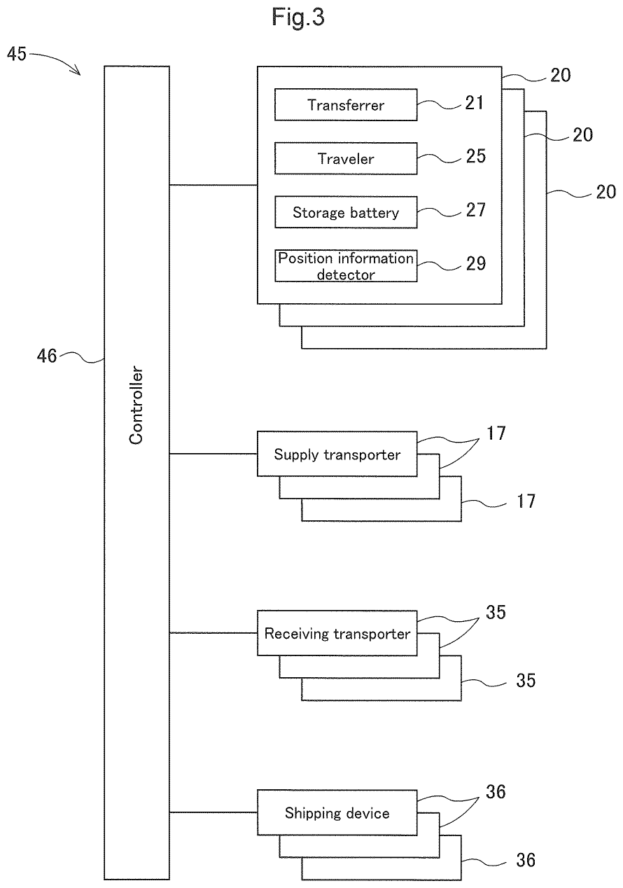

FIG. 2 is a front view of a receiving area E3. In the present embodiment, the receiving area E3 has the two ends in the X-direction along which the multiple receivers 31 are arranged in the Y-direction. In the present embodiment, each transport vehicle 20 includes a transferrer 21 that transfers an article W from the transport vehicle 20 to a receiver 31. The transferrer 21 has a receiving surface 22 on which the article W is placeable. The receiving surface 22 is switchable between a horizontal orientation and a tilting orientation. While being transported, the article W is placed on the receiving surface 22 in the horizontal orientation. When the receiving surface 22 is in the tilting orientation, the article W is transferred to the receiver 31. In the present embodiment, each transport vehicle 20 includes a traveler 25. The traveler 25 includes multiple wheels 23 that roll on the travel surface on the floor E. Examples of the transport vehicles 20 include electric vehicles that travel on electricity supplied from storage batteries or fuel cells, or through contact or contactless power feed from the floor E and include vehicles with internal combustion engines. In the present embodiment, the traveler 25 in each transport vehicle 20 incorporates a storage battery 27 (refer to FIG. 3). In the present embodiment, the transport vehicles 20 are electric automated guided vehicles.

In the present embodiment, each receiver 31 includes a receiving transporter 35. Articles W transferred to the receivers 31 are transported in the X-direction by the receiving transporters 35 to be placed in containers 38 for the respective receivers 31. In the present embodiment, the receiving transporters 35 are adjacent to shipping devices 36. The containers 38 are arranged on the shipping devices 36. When articles W of a type and in a quantity specified in one piece of order information are placed in a container 38, the corresponding shipping device 36 transports the container 38 to a shipping location. Examples of the receiving transporters 35 include belt conveyors, cranes, and robotic arms. Examples of the shipping devices 36 include belt conveyors, stacker cranes, and automated guided vehicles.

FIG. 3 is a control block diagram of the article sorting facility 10 according to the present embodiment. In the present embodiment, the article sorting facility 10 includes a control system 45 that controls the transport vehicles 20. In the illustrated example, the control system 45 includes a controller 46 that controls the transferrer 21 and the traveler 25 in each transport vehicle 20, the supply transporters 17, the receiving transporters 35, and the shipping devices 36. The controller 46 includes an arithmetic processor such as a central processing unit (CPU) and a main storage such as a random-access memory (RAM) or a read-only memory (ROM) that can be referenced by the arithmetic processor. The functions of the controller 46 (e.g., the function of controlling the travel of the transport vehicles 20) are implemented by the hardware in the controller 46 cooperating with a program executed on the arithmetic processor or other pieces of hardware. More specifically, each function of the controller 46 is implemented by the controller 46 executing a program stored in a storage (e.g., the main storage or a storage separate from the main storage). In other words, the program (e.g., an article transport program) for causing a computer (a computer in the control system 45) to implement the functions of the controller 46 is stored in a storage that can be referenced by the computer. The program is provided by, for example, a storage medium or through a communication network. The provided program is then stored into the storage that can be referenced by the computer. In the present embodiment, the controller 46 (more specifically, the arithmetic processor in the controller 46) functions as the computer. The controller 46 may be a set of multiple pieces of hardware (multiple separate pieces of hardware) that can communicate with one another through wires or wirelessly, rather than a single piece of hardware. For example, the controller 46 may include a host controller disposed in a control facility (not shown) to control the transport vehicles 20, and controllers mounted on the respective transport vehicles 20.

In the present embodiment, the floor E is divided into multiple virtual subareas Au in a grid as viewed in the Z-direction. Travel paths for the transport vehicles 20 connect any number of virtual subareas Au to one another. In the present embodiment, each transport vehicle 20 includes a position information detector 29 (refer to FIG. 3). Each virtual subarea Au includes a position information holder. When the transport vehicles 20 travel on the travel paths, the position information detector 29 in each transport vehicle 20 detects position information held by the position information holder in each virtual subarea Au. Examples of the position information holder include a barcode (one-dimensional code), a two-dimensional code, and a radio-frequency identification tag. The position information detected by the position information detector 29 is transmitted from each transport vehicle 20 to the controller 46 in the control system 45. The multiple virtual subareas Au are each sized to accommodate a transport vehicle 20.

In the present embodiment, the control system 45 provides, for example, a transport command to each transport vehicle 20. The transport command specifies the source and the destination of an article W. In the present embodiment, the source is one of the supply units 15. The destination is one of the receivers 31. The transport command also specifies the travel path for the transport vehicle 20 to travel from the source to the destination. Upon receiving the transport command from the control system 45, the transport vehicle 20 receives an article W at the specified source and transports the article W to the specified destination.

The transport command in the present embodiment defines an outgoing path for a transport vehicle 20 to travel from one of the supply units 15 to a terminal end of one of the receiving areas E3. The transport command in the present embodiment also defines a return path for a transport vehicle 20 to travel from a terminal end of one of the receiving areas E3 to one of the supply units 15. In the present embodiment, the terminal end of the receiving area E3 is an end of the receiving area E3 on the second side Y2 in the Y-direction.

In the present embodiment, the control system 45 performs, at each receiver 31, a batch process of receiving articles W of a type and in a quantity specified in one piece of order information. In the present embodiment, one container 38 is used for one piece of order information. The control system 45 places, in the batch process, the articles W of the type and in the quantity specified in one piece of order information into a container 38 (refer to FIG. 2) adjacent to the receiver 31. When the batch process is complete, or in other words, when all the articles W of the type and in the quantity specified in one piece of order information is placed in the container 38, the container 38 is transported to the shipping location. Another container 38 corresponding to a subsequent piece of order information is then placed adjacent to the receiver 31. The control system 45 performs a subsequent batch process and places the articles W of the type and in the quantity specified in the subsequent piece of order information into the subsequent container 38.

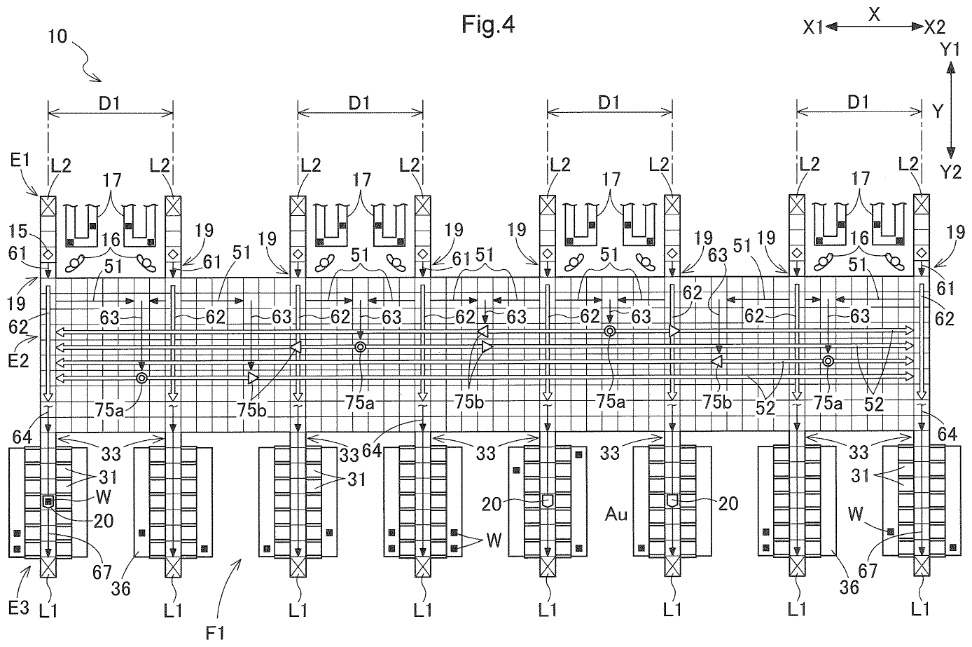

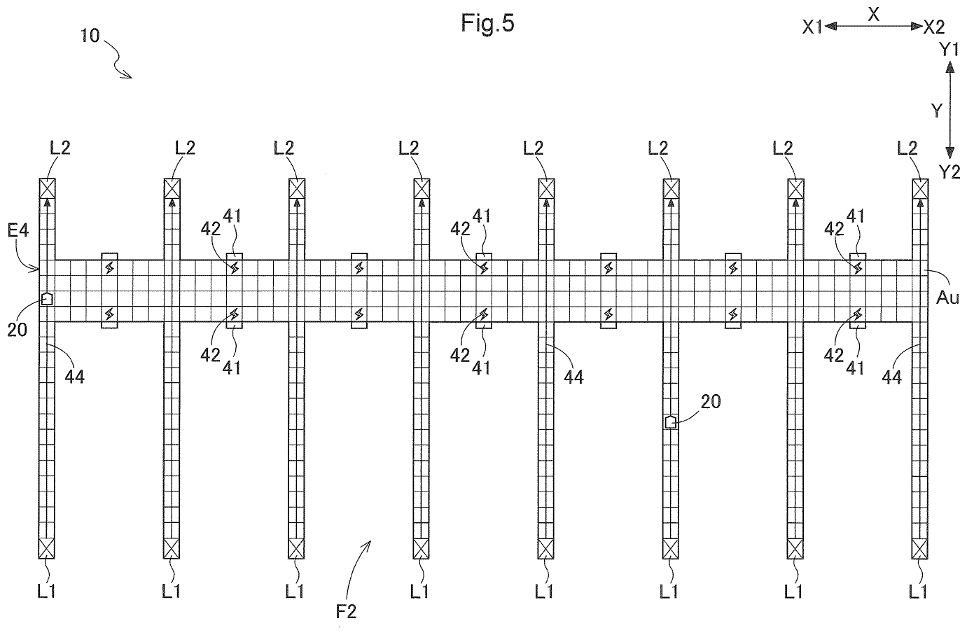

In the present embodiment, the floor E includes multiple layers on each of which the transport vehicles 20 are travelable. The layers are at different heights in the Z-direction. FIG. 4 is a diagram of a first layer F1 in the article sorting facility 10. FIG. 5 is a diagram of a second layer F2 in the article sorting facility 10. In the example in FIGS. 4 and 5, the floor E includes the first layer F1 and the second layer F2 adjacent to each other in the Z-direction. Although the second layer F2 is disposed above the first layer F1 in the present embodiment, the second layer F2 may be below the first layer F1. In the present embodiment, the first layer F1 includes the supply areas E1, the connection area E2, and the receiving areas E3.

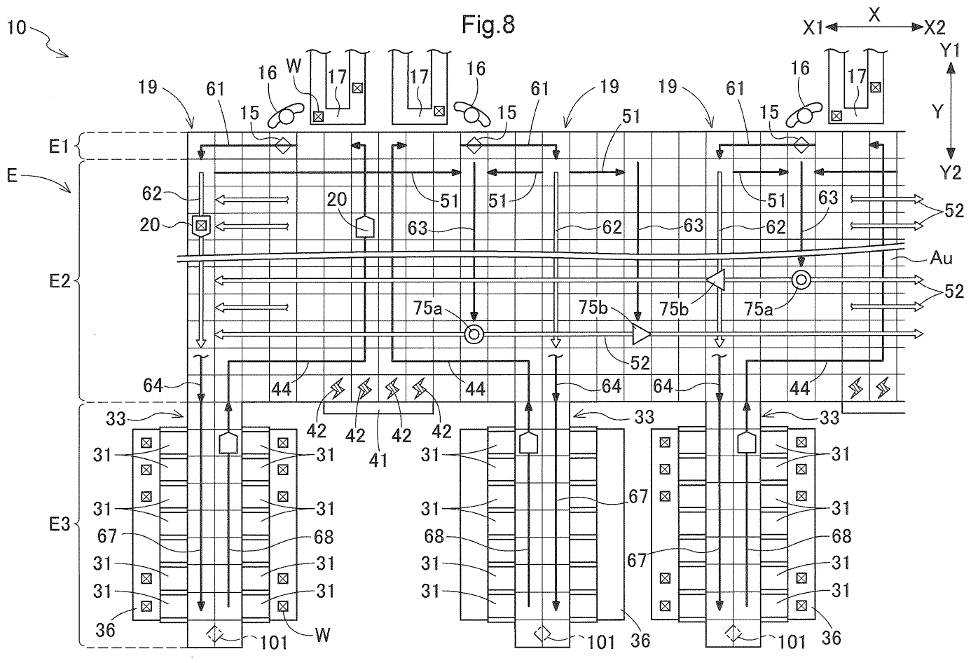

Although not illustrated in FIG. 4, in the present embodiment, the connection area E2 includes charging positions 42 (refer to FIG. 8) for charging the transport vehicles 20 with a charger 41. This allows efficient use of the connection area E2, which includes no supply unit 15 and no receiver 31. In the example in FIG. 8, the charger 41 is disposed adjacent to the connection area E2. The charging positions 42 are arranged to allow multiple transport vehicles 20 to stop at the charging positions 42.

In the present embodiment, each transport vehicle 20 moves to and stops at a charging position 42 when the remaining battery level is less than a predetermined level (e.g., less than 50% of the full capacity). At the charging position 42, the storage battery 27 (refer to FIG. 3) in the transport vehicle 20 can be charged rapidly. The charger 41 may be a contactless power feeder or a contact power feeder. In the present embodiment, the controller 46 included in the control system 45 (described later) obtains the remaining level of the storage battery 27 in each transport vehicle 20 and controls any transport vehicle 20 with less than a predetermined battery level to move to the charging position 42.

In the present embodiment, the article sorting facility 10 includes first lifters L1 connecting the first layer F1 and the second layer F2 to lift and lower the transport vehicles 20. In the illustrated example, the first lifters L1 are on the second side Y2 in the Y-direction of the floor E. The first lifters L1 are connected to the receiving areas E3 on the first layer F1 and to the second layer F2. The first lifters L1 may autonomously transport the transport vehicles 20 or may be controlled by the control system 45. Examples of the first lifters L1 include lifters that circulate the transport vehicles 20 along a predetermined annular path, lifters that lift and lower the transport vehicles 20 in the Z-direction, and multicopters or cranes that can transport the transport vehicles 20.

In the present embodiment, the article sorting facility 10 includes second lifters L2 connecting the first layer F1 and the second layer F2 to lift and lower the transport vehicles 20. In the illustrated example, the second lifters L2 are on the first side Y1 in the Y-direction of the floor E. The second lifters L2 are connected to the supply areas E1 on the first layer F1 and to the second layer F2. The first lifters L1 and the second lifters L2 are spaced from each other in the horizontal direction. The second lifters L2 may autonomously transport the transport vehicles 20 or may be controlled by the control system 45. Examples of the second lifters L2 include lifters that circulate the transport vehicles 20 along a predetermined annular path, lifters that lift and lower the transport vehicles 20 in the Z-direction, and multicopters or cranes that can transport the transport vehicles 20.

In the present embodiment, the second layer F2 includes back paths 44 on which the transport vehicles 20 travel. The first lifters L1 and the second lifters L2 are connected with the back paths 44 on the second layer F2 to allow the transport vehicles 20 to travel. In the illustrated examples, the second lifters L2 are connected to the back paths 44 and to the first layer F1. The second lifters L2 may be directly or indirectly connected to the back paths 44. The second lifters L2 may be directly or indirectly connected to the supply areas E1. After transporting the articles W to the receivers 31 in the receiving areas E3, the transport vehicles 20 travel on the back paths 44 being a part of the return path described above. In the present embodiment, each back path 44 is a one-way path.

In the present embodiment, the first lifters L1 are connected to starting ends of the back paths 44 and to the terminal ends of the receiving areas E3. The second lifters L2 are connected to terminal ends of the back paths 44 and to the supply areas E1. In the illustrated example, the multiple back paths 44 are arranged on the second layer F2 and each extend in the Y-direction. In the present embodiment, the second layer F2 includes an aisle connection area E4 connecting the multiple back paths 44 to allow the transport vehicles 20 to travel between the back paths 44. In the illustrated example, the aisle connection area E4 is disposed between back paths 44 adjacent to each other in the X-direction. The aisle connection area E4 includes the charging positions 42 for charging the transport vehicles 20.

The connection area E2 includes multiple Y-direction paths 62 arranged in the X-direction. The Y-direction paths 62 are paths on which the transport vehicles 20 travel in the Y-direction. The Y-direction paths 62 as many as the entrances 19 are arranged in the X-direction. In the present embodiment, each Y-direction path 62 is a one-way path. The number of multiple Y-direction paths 62 may be the same as the number of entrances 19. Among the multiple Y-direction paths 62, the Y-direction paths 62 as many as the entrances 19 may be arranged in the X-direction.

The connection area E2 includes multiple X-direction paths 52 arranged in the Y-direction. The X-direction paths 52 are paths on which the transport vehicles 20 travel in the X-direction. Examples of the number of X-direction paths 52 arranged in the Y-direction include three-quarters or less of the number of entrances 19, one-half or less of the number of entrances 19, one-third or less of the number of entrances 19, and one-quarter or less of the number of entrances 19. In the present embodiment, each X-direction path 52 is a one-way path.

In the present embodiment, the distance in the X-direction between a pair of Y-direction paths 62 adjacent to each other is greater than the distance in the Y-direction between a pair of X-direction paths 52 adjacent to each other. The distance in the X-direction between a pair of Y-direction paths 62 adjacent to each other and the distance in the Y-direction between a pair of X-direction paths 52 adjacent to each other are compared with each other using, for example, the average values of these distances.

In the present embodiment, each of the multiple entrances 19 is associated with one Y-direction path 62. When a transport vehicle 20 entering the connection area E2 through an entrance 19 travels in the Y-direction, the transport vehicle 20 travels on the Y-direction path 62 associated with the entrance 19. In the illustrated example, each of the multiple entrances 19 is associated with a different one of the Y-direction paths 62 as a Y-direction corresponding path. In FIG. 4, for example, the Y-direction paths 62 that can be the Y-direction corresponding paths are indicated by the outlined arrows extending in the Y-direction.

An area between each pair of Y-direction paths 62 adjacent to each other in the X-direction on the floor E is referred to as a Y-direction inter-path area. The floor E includes an auxiliary Y-direction path 63 in at least one of the multiple Y-direction inter-path areas. The auxiliary Y-direction path 63 is a path on which the transport vehicles 20 travel in the Y-direction. The auxiliary Y-direction path 63 branches from at least one of a pair of Y-direction paths 62 adjacent to each other in the X-direction. For example, two or more Y-direction inter-path areas, or 25%, 50%, or 75% or more of the Y-direction inter-path areas include the auxiliary Y-direction path 63. In the illustrated example, each auxiliary Y-direction path 63 is a one-way path.

In the present embodiment, the connection area E2 includes branching X-direction paths 51 on which the transport vehicles 20 traveling from the Y-direction paths 62 travel in the X-direction before merging into the auxiliary Y-direction paths 63. In the illustrated example, each branching X-direction path 51 is a one-way path.

In the present embodiment, each of the multiple entrances 19 is associated with one X-direction path 52 as an X-direction corresponding path. When a transport vehicle 20 entering the connection area E2 through an entrance 19 travels in the X-direction, the transport vehicle 20 turns toward the first side X1 in the X-direction or the second side X2 in the X-direction on the X-direction corresponding path associated with the entrance 19. In FIG. 4, for example, the X-direction paths 52 that can be the X-direction corresponding paths are selectively indicated by the outlined arrows extending in the X-direction.

In the present embodiment, a transport vehicle 20 travels on the auxiliary Y-direction path 63 when entering the connection area E2 through an entrance 19 (in the example in FIG. 4, the first and second entrances 19 from the first side X1 in the X-direction) having the X-direction corresponding path being the X-direction path 52 farthest on the second side Y2 in the Y-direction. In the present embodiment, a transport vehicle 20 also travels on the auxiliary Y-direction path 63 when entering the connection area E2 through the entrance 19 having the X-direction corresponding path being the second, third, or fourth X-direction path 52 from the second side Y2 in the Y-direction.

Unlike the example in FIG. 4, a transport vehicle 20 may also travel on the auxiliary Y-direction path 63 when entering the connection area E2 through the entrance 19, excluding the entrances 19 at the outermost ends in the X-direction, having the X-direction corresponding path being the X-direction path 52 farthest on the second side Y2 in the Y-direction. In other words, a transport vehicle 20 may not travel on the auxiliary Y-direction path 63 when entering the connection area E2 through one of the entrances 19 at the outermost ends in the X-direction.

In the present embodiment, each X-direction corresponding path is associated with two or more entrances 19. In the illustrated example, a pair of entrances 19 adjacent to each other in the X-direction is associated with one X-direction path 52 as an X-direction corresponding path.

In the present embodiment, the X-direction corresponding paths associated with the respective entrances 19 are arranged toward the second side Y2 in the Y-direction as the respective entrances 19 are arranged closer to the outermost ends of the connection area E2 in the X-direction. When multiple entrances 19 adjacent to each other are associated with one X-direction corresponding path, these entrances 19 may be referred to as one entrance 19. In the example in FIG. 4, two adjacent entrances 19 are associated with one of four X-direction paths 52 as the X-direction corresponding path. More specifically, two entrances 19 being the first and second entrances 19 from the first side X1 in the X-direction are associated with the X-direction path 52 farthest on the second side Y2 in the Y-direction. Two entrances 19 being the first and second entrances 19 from the second side X2 in the X-direction are associated with the second X-direction path 52 from the second side Y2 in the Y-direction. Two entrances 19 being the third and fourth entrances 19 from the first side X1 in the X-direction are associated with the third X-direction path 52 from the second side Y2 in the Y-direction. Two entrances 19 being the third and fourth entrances 19 from the second side X2 in the X-direction are associated with the fourth X-direction path 52 from the second side Y2 in the Y-direction.

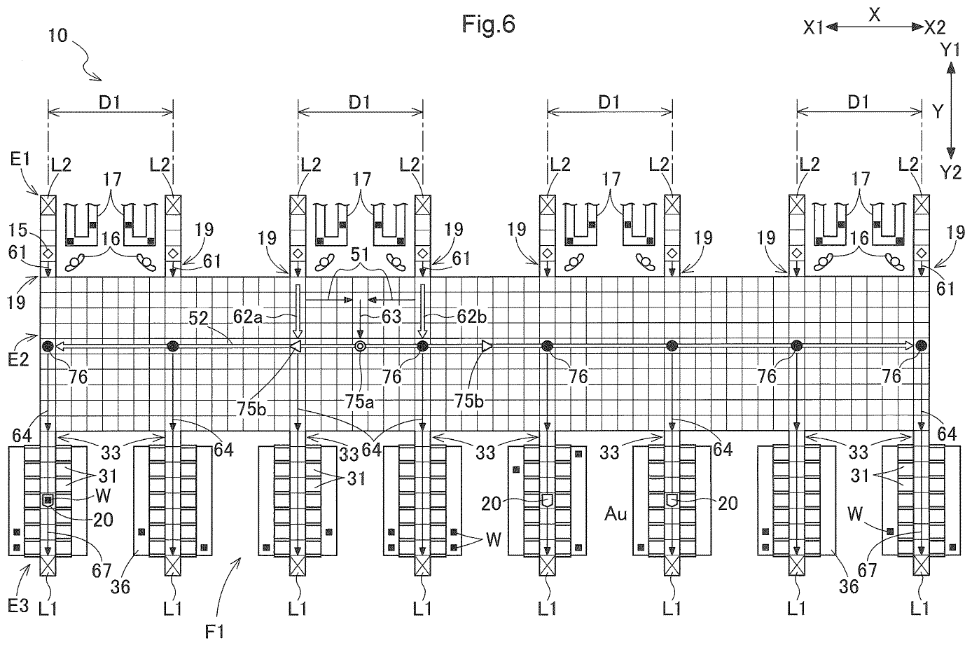

FIG. 6 is a diagram of a first side Y-direction path 62a and a second side Y-direction path 62b. The Y-direction path 62 adjacent to the auxiliary Y-direction path 63 on the first side X1 in the X-direction is the first side Y-direction path 62a. The Y-direction path 62 adjacent to the auxiliary Y-direction path 63 on the second side X2 in the X-direction is the second side Y-direction path 62b. A pair of entrances 19 associated with one X-direction corresponding path is an entrance pair. In the present embodiment, the auxiliary Y-direction path 63 is disposed in the Y-direction inter-path area between the Y-direction paths 62 associated with the respective entrances 19 of the entrance pair.

In the present embodiment, the Y-direction paths 62 each associated with the corresponding entrance 19 of the entrance pair include the first side Y-direction path 62a on the first side X1 in the X-direction, and the second side Y-direction path 62b on the second side X2 in the X-direction.

As shown in FIGS. 4 and 6, in the present embodiment, a transport vehicle 20 traveling on the first side Y-direction path 62a toward an exit 33 on the second side X2 in the X-direction relative to the first side Y-direction path 62a travels on the auxiliary Y-direction path 63. Some of the transport vehicles 20 traveling toward the exit 33 may travel on the auxiliary Y-direction path 63, or all of the transport vehicles 20 traveling toward the exit 33 may travel on the auxiliary Y-direction path 63. A transport vehicle 20 traveling on the first side Y-direction path 62a toward the exit 33 on the first side X1 in the X-direction relative to the first side Y-direction path 62a may travel on another auxiliary Y-direction path 63. Another auxiliary Y-direction path 63 may not be disposed. The transport vehicle 20 may thus travel on the first side Y-direction path 62a toward the X-direction corresponding path.

In the present embodiment, a transport vehicle 20 traveling on the second side Y-direction path 62b toward the exit 33 on the first side X1 in the X-direction relative to the second side Y-direction path 62b travels on the auxiliary Y-direction path 63. Some of the transport vehicles 20 traveling toward the exit 33 may travel on the auxiliary Y-direction path 63, or all of the transport vehicles 20 traveling toward the exit 33 may travel on the auxiliary Y-direction path 63. A transport vehicle 20 traveling on the second side Y-direction path 62b toward the exit 33 on the second side X2 in the X-direction relative to the second side Y-direction path 62b may travel on another auxiliary Y-direction path 63. Another auxiliary Y-direction path 63 may not be disposed. The transport vehicle 20 may thus travel on the second side Y-direction path 62b toward the X-direction corresponding path.

In the present embodiment, the transport vehicle 20 traveling on the first side Y-direction path 62a toward the exit 33 on the second side X2 in the X-direction relative to the first side Y-direction path 62a and the transport vehicle 20 traveling on the second side Y-direction path 62b toward the exit 33 on the first side X1 in the X-direction relative to the second side Y-direction path 62b travel on the same auxiliary Y-direction path 63.

In the present embodiment, a transport vehicle 20 traveling on the first side Y-direction path 62a toward the exit 33 on the second side X2 in the X-direction relative to the first side Y-direction path 62a travels on the X-direction corresponding path toward the second side X2 in the X-direction after traveling on the auxiliary Y-direction path 63. Some of the transport vehicles 20 traveling toward the exit 33 may travel on the X-direction corresponding path toward the second side X2 in the X-direction after traveling on the auxiliary Y-direction path 63, or all of the transport vehicles 20 traveling toward the exit 33 may travel on the X-direction corresponding path toward the second side X2 in the X-direction after traveling on the auxiliary Y-direction path 63. A transport vehicle 20 traveling on the first side Y-direction path 62a toward the exit 33 on the first side X1 in the X-direction relative to the first side Y-direction path 62a may travel on the X-direction corresponding path toward the first side X1 in the X-direction after traveling on another auxiliary Y-direction path 63. Another auxiliary Y-direction path 63 may not be disposed. The transport vehicle 20 may thus travel on the first side Y-direction path 62a toward the X-direction corresponding path.

In the present embodiment, a transport vehicle 20 traveling on the second side Y-direction path 62b toward the exit 33 on the first side X1 in the X-direction relative to the second side Y-direction path 62b travels on the X-direction corresponding path toward the first side X1 in the X-direction after traveling on the auxiliary Y-direction path 63. Some of the transport vehicles 20 traveling toward the exit 33 may travel on the X-direction corresponding path toward the first side X1 in the X-direction after traveling on the auxiliary Y-direction path 63, or all of the transport vehicles 20 traveling toward the exit 33 may travel on the X-direction corresponding path toward the second side X2 in the X-direction after traveling on the auxiliary Y-direction path 63. A transport vehicle 20 traveling on the second side Y-direction path 62b toward the exit 33 on the second side X2 in the X-direction relative to the second side Y-direction path 62b may travel on the X-direction corresponding path toward the second side X2 in the X-direction after traveling on another auxiliary Y-direction path 63. Another auxiliary Y-direction path 63 may not be disposed. The transport vehicle 20 may thus travel on the second side Y-direction path 62b toward the X-direction corresponding path.

In the present embodiment, a transport vehicle 20 traveling toward the exit 33 on the first side X1 in the X-direction relative to the first side Y-direction path 62a after traveling on the first side Y-direction path 62a does not travel on the auxiliary Y-direction path 63 disposed in the Y-direction inter-path area between the Y-direction paths 62 associated with the respective entrances 19 of the entrance pair. A transport vehicle 20 traveling toward the exit 33 on the second side X2 in the X-direction relative to the second side Y-direction path 62b after traveling on the second side Y-direction path 62b does not travel on the auxiliary Y-direction path 63 disposed in the Y-direction inter-path area between the Y-direction paths 62 associated with the respective entrances 19 of the entrance pair.

In the present embodiment, the branching X-direction paths 51 on which the transport vehicles 20 traveling from the respective Y-direction paths 62 travel in the X-direction before merging into the auxiliary Y-direction paths 63 are on the first side Y1 in the Y-direction relative to the multiple X-direction paths 52. The branching X-direction paths 51 are on the first side Y1 in the Y-direction relative to the multiple X-direction corresponding paths.

Travel paths for the transport vehicles 20 traveling toward the respective entrances 19 in the multiple supply areas E1 are supply paths 61. Travel paths for the transport vehicles 20 traveling from the respective exits 33 toward the ends of the corresponding receiving areas E3 are receiving outgoing paths 67. In the present embodiment, the supply paths 61 extend in the Y-direction and are connected linearly to the respective Y-direction paths 62. Each supply path 61 is a one-way path. Each receiving outgoing path 67 is a one-way path.

In the present embodiment, corresponding exiting paths 64 are arranged in the X-direction. The number of corresponding exiting paths 64 is greater than or equal to the number of exits 33. Each of the multiple exits 33 is associated with one path in the Y-direction as the corresponding exiting path 64. Each of the multiple exits 33 is associated with a different path in the Y-direction as a corresponding exiting path 64. The corresponding exiting paths 64 are connected linearly to the respective receiving outgoing paths 67. Each corresponding exiting path 64 is a one-way path.

In the present embodiment, the X-direction paths 52 and the auxiliary Y-direction paths 63 or the Y-direction paths 62 intersect at turning positions (75a, 75b) at which the transport vehicles 20 entering the connection area E2 through the respective entrances 19 turn toward the first side X1 in the X-direction or the second side X2 in the X-direction.

In the present embodiment, the turning positions include bidirectional turning positions 75a. A transport vehicle 20 entering the connection area E2 through the entrance 19 can turn toward the first side X1 in the X-direction or the second side X2 in the X-direction at the bidirectional turning position 75a. In the illustrated example, a transport vehicle 20 traveling on a branching X-direction path 51 toward the first side X1 in the X-direction turns toward the first side X1 in the X-direction at the bidirectional turning position 75a after traveling on the auxiliary Y-direction path 63. A transport vehicle 20 traveling on a branching X-direction path 51 toward the second side X2 in the X-direction turns toward the second side X2 in the X-direction at the bidirectional turning position 75a after traveling on the auxiliary Y-direction path 63.

In the present embodiment, the turning positions include unidirectional turning positions 75b. The transport vehicle 20 can simply turn toward one of the first side X1 in the X-direction or the second side X2 in the X-direction at the unidirectional turning position 75b.

In the present embodiment, when a transport vehicle 20 entering the connection area E2 through an entrance 19 does not travel on the X-direction corresponding path associated with the entrance 19, the transport vehicle 20 travels toward the exit 33 without traveling on the branching X-direction path 51. In the illustrated example, when the transport vehicle 20 travels toward the exit 33 aligned with the entrance 19 as viewed in the Y-direction, the transport vehicle 20 travels on the corresponding exiting path 64 associated with the exit 33 without traveling on the X-direction path 52 and the X-direction corresponding path.

The corresponding exiting paths 64 and exiting turning positions 76 will now be described with reference to FIG. 6. FIG. 6 simply illustrates a first side Y-direction path 62a, a second side Y-direction path 62b, branching X-direction paths 51, and an X-direction path 52 as the X-direction corresponding path, which are associated with one pair of entrances 19 as one entrance pair. In the present embodiment, when a transport vehicle 20 traveling on a Y-direction path 62 does not travel on the X-direction corresponding path, the transport vehicle 20 travels toward the exit 33 without traveling on the branching X-direction path 51.

In the example in FIG. 6, when a transport vehicle 20 travels toward the first side X1 in the X-direction relative to the first side Y-direction path 62a or travels toward the exit 33 in the straight direction after traveling on the first side Y-direction path 62a, the transport vehicle 20 does not travel on the branching X-direction path 51. When a transport vehicle 20 travels toward the exit 33 on the second side X2 in the X-direction relative to the first side Y-direction path 62a after traveling on the first side Y-direction path 62a, the transport vehicle 20 travels on the branching X-direction path 51.

In the example in FIG. 6, when a transport vehicle 20 travels toward the exit 33 in the straight direction relative to the second side Y-direction path 62b after traveling on the second side Y-direction path 62b, the transport vehicle 20 does not travel on the branching X-direction path 51. When a transport vehicle 20 travels toward the exit 33 on the first side X1 in the X-direction relative to the second side Y-direction path 62b after traveling on the second side Y-direction path 62b, the transport vehicle 20 travels on the branching X-direction path 51 on the first side X1 in the X-direction relative to the second side Y-direction path 62b. When a transport vehicle 20 travels toward the exit 33 on the second side X2 in the X-direction relative to the second side Y-direction path 62b after traveling on the second side Y-direction path 62b, the transport vehicle 20 travels on the branching X-direction path 51 (refer to FIG. 4) on the second side X2 in the X-direction relative to the second side Y-direction path 62b.

In the present embodiment, a transport vehicle 20 traveling on an X-direction path 52 turns toward the second side Y2 in the Y-direction at the exiting turning position 76 associated with the receiving area E3 of a destination in the X-direction to enter the receiving area E3 of the destination. The corresponding exiting path 64 associated with the exit 33 connects the exiting turning position 76 to the exit 33 to allow the transport vehicle 20 to travel between them. In the illustrated example, the exiting turning positions 76 are aligned with the respective exits 33 as viewed in the Y-direction. As shown in FIG. 4, each Y-direction path 62 is aligned with the corresponding exiting path 64 associated with the exit 33 as viewed in the Y-direction.

Referring back to FIG. 4, each of the multiple exits 33 is associated with one Y-direction path 62 in the present embodiment. When a transport vehicle 20 travels on a Y-direction path 62 toward the exit 33 associated with the Y-direction path 62, the transport vehicle 20 does not travel on any auxiliary Y-direction path 63. In the illustrated example, each of the multiple exits 33 is associated with a different one of the Y-direction paths 62 as a Y-direction corresponding path. Each Y-direction corresponding path is aligned with the corresponding exiting path 64 as viewed in the Y-direction. The number of exits 33 and the number of entrances 19 are the same.

The exits 33 are N exits (N is a natural number greater than or equal to 2). An exit 33, among the N exits 33, corresponding to the first side Y-direction path 62a is an M-th exit from the first side X1 in the X-direction. An exit 33, among the N exits 33, corresponding to the second side Y-direction path 62b is an (M+1)th exit from the first side X1 in the X-direction. The Y-direction inter-path area between the first side Y-direction path 62a and the second side Y-direction path 62b has a length D1 in the X-direction. In the present embodiment, the auxiliary Y-direction path 63 is at a distance based on

$$Distance K = D 1 \times \{ ( N - M ) / N \} \qquad ( 1 )$$

from the first side Y-direction path 62a toward the second side X2 in the X-direction

In the present embodiment, the auxiliary Y-direction path 63 in the Y-direction inter-path area between the Y-direction paths 62 associated with the respective entrances 19 of the entrance pair is at a distance based on the distance K obtained from Formula 1 above from the first side Y-direction path 62a toward the second side X2 in the X-direction. When the distance based on the distance K is the distance K, the auxiliary Y-direction path 63 is at the distance K and on the second side X2 in the X-direction relative to the first side Y-direction path 62a.

In the illustrated example, each auxiliary Y-direction path 63 extends over virtual subareas Au with one square in the X-direction. One square corresponds to one virtual subarea Au. Each Y-direction inter-path area has a length of seven virtual subareas Au (D1=7 squares) in the X-direction. The exits 33 are eight exits 33 (N=8). When the first exit 33 from the first side X1 in the X-direction is associated with the first side Y-direction path 62a, and the second exit 33 from the first side X1 in the X-direction is associated with the second side Y-direction path 62b, M=1. Formula 1 above is used to obtain the distance K=7 squares×{⅞}=6.2 squares. Based on this value (more specifically, an integer obtained by, for example, rounding), the auxiliary Y-direction path 63 is at a position across sixth squares from the first side Y-direction path 62a and two squares from the second side Y-direction path 62b.

In the present embodiment, the Y-direction path 62 and the auxiliary Y-direction path 63 allow at least one transport vehicle 20 to wait between the Y-direction path 62 and the auxiliary Y-direction path 63 in the X-direction. In other words, one or more squares in the X-direction are between the Y-direction path 62 and the auxiliary Y-direction path 63. Thus, the auxiliary Y-direction path 63 is in the virtual subareas Au at a position across at least two squares from the first side Y-direction path 62a or the second side Y-direction path 62b in the X-direction.

In the present embodiment, the ratio of the length of the branching X-direction path 51 on which a transport vehicle 20 traveling from the first side Y-direction path 62a travels toward the second side X2 in the X-direction before merging into the auxiliary Y-direction path 63 to the length of the branching X-direction path 51 on which a transport vehicle 20 traveling from the second side Y-direction path 62b travels toward the first side X1 in the X-direction before merging into the auxiliary Y-direction path 63 is set to N−M:M or is set based on N−M:M. The length of the branching X-direction path 51 on the travel path with a higher congestion frequency may be set to be greater. The congestion frequency is calculated using, for example, the total congestion duration, the frequency of congestion, or both.

In the example in FIGS. 4 and 6, only the length in the X-direction of each Y-direction inter-path area between the Y-direction paths 62 associated with the respective entrances 19 of the entrance pair is denoted with D1. However, Formula 1 above may be applied to the Y-direction path 62 or the branching X-direction path 51 with two of the entrances 19 not serving as the entrance pair. In the example in FIG. 4, the auxiliary Y-direction path 63 in a Y-direction inter-path area between the Y-direction paths 62 associated with the respective adjacent entrances 19 not in the entrance pair is at a distance based on the distance K obtained from Formula 1 above from the Y-direction path 62 on the first side X1 in the X-direction toward the second side X2 in the X-direction.

In the present embodiment, once the entrance 19 and the exit 33 through which a transport vehicle 20 travels are determined, one travel path for the transport vehicle 20 from the entrance 19 to the exit 33 is determined. This structure reduces the likelihood of the travel control of the multiple transport vehicles 20 being complicated.

### Second Embodiment

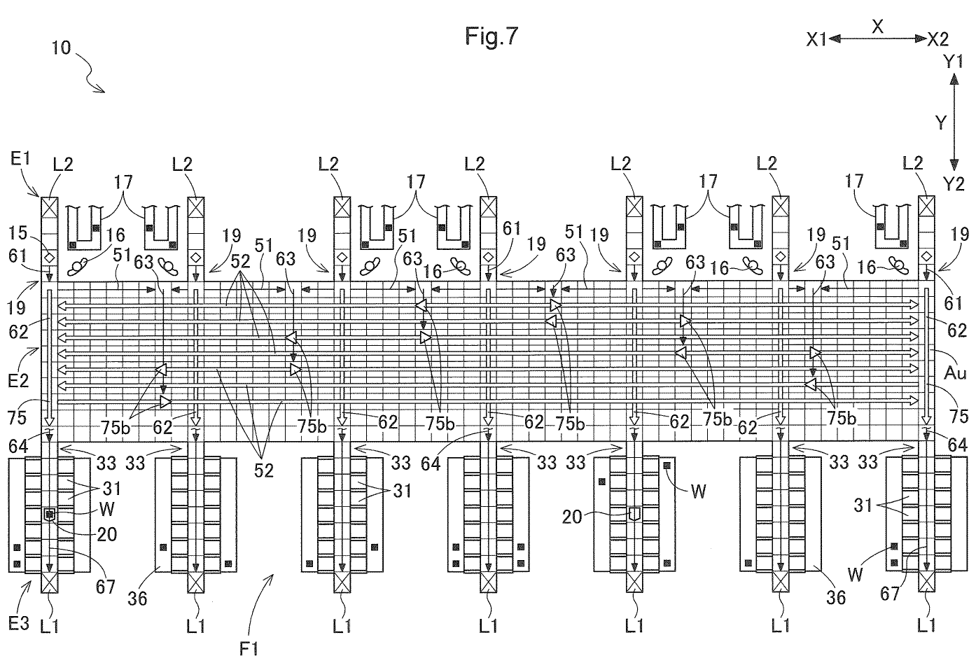

An article sorting facility 10 according to a second embodiment will be described below with reference to FIG. 7. The present embodiment differs from the first embodiment in that the number of X-direction paths 52 arranged in the Y-direction in the connection area E2 is greater than or equal to the number of entrances 19. The differences from the first embodiment will mainly be described below. The components and the structures not described below are the same as those in the first embodiment.

In the present embodiment, each of the multiple entrances 19 is associated with a different one of the X-direction paths 52 as an X-direction corresponding path. In the illustrated example, the number of X-direction paths 52 in the connection area E2 and the number of entrances 19 are the same. The number of X-direction paths 52 in the connection area E2 and the number of X-direction corresponding paths are also the same.

In the present embodiment, the X-direction paths 52 and the auxiliary Y-direction paths 63 intersect at turning positions at which the transport vehicles 20 entering the connection area E2 through the respective entrances 19 turn toward the first side X1 or the second side X2 in the X-direction after traveling on the respective auxiliary Y-direction paths 63. These turning positions are the unidirectional turning positions 75b.

In the present embodiment, one auxiliary Y-direction path 63 is between the Y-direction paths 62 corresponding to the respective entrances 19 adjacent to each other. In some embodiments, multiple auxiliary Y-direction paths 63 may be between the Y-direction paths 62 corresponding to the respective entrances 19 adjacent to each other. In the present embodiment, a transport vehicle 20 traveling through the entrance 19 on the first side X1 in the X-direction, among the adjacent entrances 19 and traveling on a branching X-direction path 51 toward the second side X2 in the X-direction and a transport vehicle 20 traveling through the entrance 19 on the second side X2 in the X-direction and further traveling on a branching X-direction path 51 toward the first side X1 in the X-direction may travel on the same auxiliary Y-direction path 63 or on different auxiliary Y-direction paths 63.

### Third Embodiment

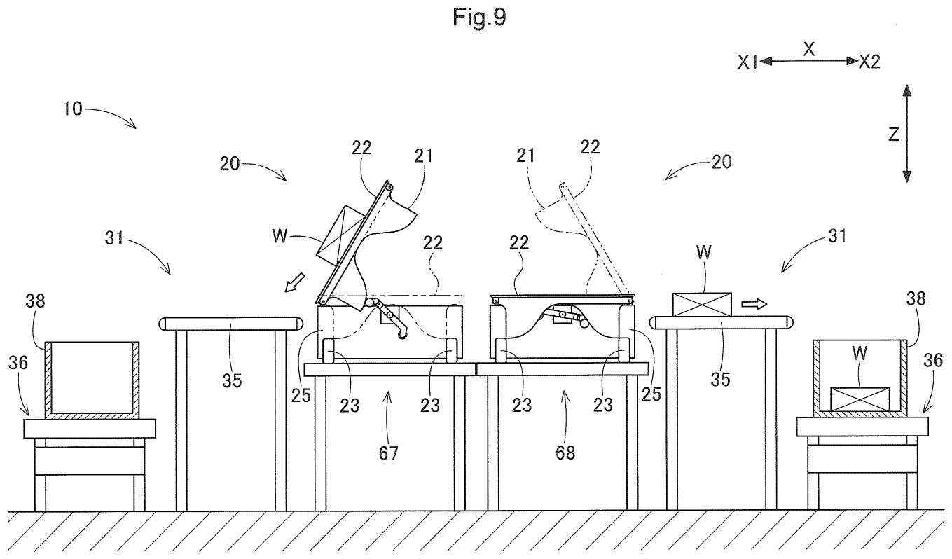

An article sorting facility 10 according to a third embodiment will be described below with reference to FIGS. 8 and 9. In the present embodiment, the floor E on which the multiple transport vehicles 20 travel includes a single layer, unlike in the first embodiment. The differences from the first embodiment will mainly be described below. The components and the structures not described below are the same as those in the first embodiment.

FIG. 8 is atop view of the article sorting facility 10 according to the present embodiment. FIG. 9 is a front view of the receiving area E3 in the present embodiment. In the present embodiment, the article sorting facility 10 includes receiving U-turn positions 101 on the second side Y2 in the Y-direction relative to the exits 33. In the illustrated example, the receiving U-turn positions 101 are at the terminal ends of the receiving areas E3 on the second side Y2 in the Y-direction.

In the present embodiment, each receiving area E3 includes a receiving outgoing path 67 to allow the transport vehicles 20 to travel from the exit 33 to the receiving U-turn position 101. Each receiving area E3 also includes a receiving return path 68 to allow the transport vehicles 20 that have U-turned at the receiving U-turn position 101 to travel from the receiving U-turn position 101 to the exit 33. The connection area E2 includes the back paths 44 to allow the transport vehicles 20 to travel from the exits 33 to the respective supply areas E1.

In the present embodiment, the receiving outgoing path 67 and the receiving return path 68 are arranged in the X-direction in each receiving area E3. In the receiving area E3, each transport vehicle 20 transfers an article W to the receiver 31 in the manner described below. Specifically, as shown in FIGS. 8 and 9, on the receiving outgoing path 67, the transport vehicles 20 transfer articles W to the receivers 31 arranged opposite to the receiving return path 68 in the X-direction. On the receiving return path 68, the transport vehicles 20 transfer articles W to the receivers 31 arranged opposite to the receiving outgoing path 67 in the X-direction. In the present embodiment, each receiving return path 68 is a one-way path.

### Fourth Embodiment

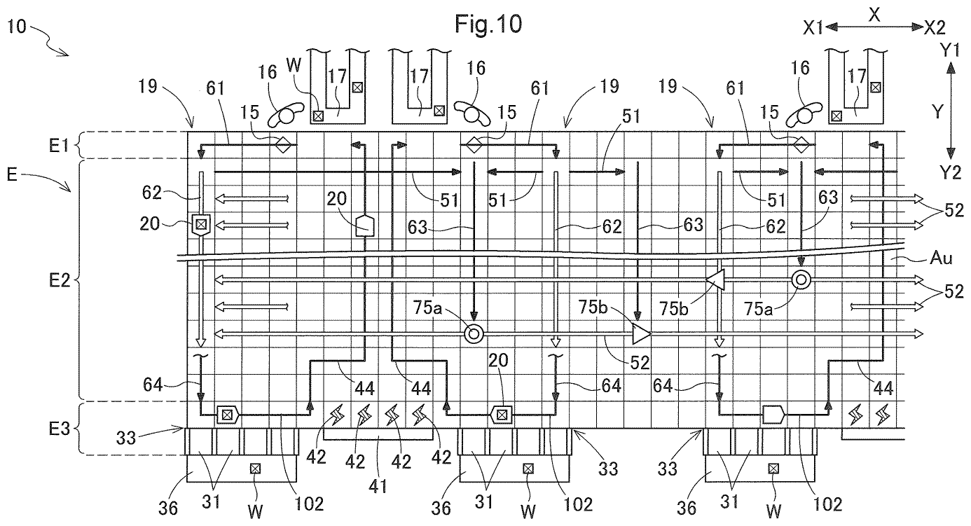

An article sorting facility 10 according to a fourth embodiment will be described below with reference to FIG. 10. In the present embodiment, the receiving areas E3 do not include an aisle area, unlike in the third embodiment. The differences from the third embodiment will mainly be described below. The components and the structures not described below are the same as those in the third embodiment.

FIG. 10 is a top view of the article sorting facility 10 according to the present embodiment, corresponding to FIG. 8. In the present embodiment, the receiving areas E3 arranged in the X-direction each include multiple receivers 31. The multiple receivers 31 in each receiving area E3 are arranged in the X-direction. Each receiving area E3 includes a receiving path 102 extending in the X-direction. The transport vehicles 20 transfer the articles W to the respective receivers 31 arranged in the X-direction and adjacent to the receiving paths 102 on the second side Y2 in the Y-direction. In the present embodiment, each receiving path 102 is a one-way path.

### Other Embodiments

An article sorting facility 10 according to other embodiments will now be described.

(1) In the above embodiments, a pair of entrances 19 is associated with one X-direction corresponding path. However, the disclosure is not limited to this structure. For example, three or more entrances 19 may be associated with one X-direction corresponding path. For example, the entrances 19 may each be associated with the same number of or a different number of multiple X-direction corresponding paths. For example, the multiple entrances 19 may each be associated with a different number of X-direction corresponding paths, in a manner such as some entrances 19 being associated with three X-direction corresponding paths and the other being associated with two X-direction corresponding paths. For example, the X-direction corresponding paths, the Y-direction corresponding paths, or the corresponding exiting paths 64 may not be straight and may each include a curved portion. For example, the article sorting facility 10 may include, adjacent to the connection area E2, another area including dedicated paths each connecting one entrance 19 in the supply area E1 to one exit 33 in the receiving area E3.

(2) In the above embodiments, the distance in the X-direction between a pair of Y-direction paths 62 adjacent to each other is greater than the distance in the Y-direction between a pair of X-direction paths 52 adjacent to each other. However, the disclosure is not limited to this structure. For example, the distance in the X-direction between a pair of Y-direction paths 62 adjacent to each other may be less than or equal to the distance in the Y-direction between a pair of X-direction paths 52 adjacent to each other.

(3) In the above embodiments, a transport vehicle 20 traveling on the first side Y-direction path 62a toward the exit 33 on the second side X2 in the X-direction relative to the first side Y-direction path 62a travels on the auxiliary Y-direction path 63. However, the disclosure is not limited to this structure. For example, a transport vehicle 20 traveling on the first side Y-direction path 62a toward the exit 33 on the second side X2 in the X-direction relative to the first side Y-direction path 62a may enter the corresponding X-direction path intersecting with the first side Y-direction path 62a without traveling on the auxiliary Y-direction path 63.

(4) In the above embodiments, the branching X-direction paths 51 are on the first side Y1 in the Y-direction relative to the multiple X-direction paths 52. However, the disclosure is not limited to this structure. For example, the branching X-direction paths 51 may be between the multiple X-direction paths 52 in the Y-direction.

(5) In the above embodiments, a transport vehicle 20 travels on the auxiliary Y-direction path 63 when entering the connection area E2 through the entrance 19 having the X-direction corresponding path being the X-direction path 52 farthest on the second side Y2 in the Y-direction. However, the disclosure is not limited to this structure. For example, a transport vehicle 20 may not travel on the auxiliary Y-direction path 63 when entering the connection area E2 through the entrance 19 having the X-direction corresponding paths being the first and second X-direction paths 52 from the second side Y2 in the Y-direction. For example, a transport vehicle 20 may turn toward the first side X1 or the second side X2 in the X-direction to enter the X-direction corresponding path.

(6) In the above embodiments, a transport vehicle 20 traveling on the first side Y-direction path 62a toward the exit 33 on the second side X2 in the X-direction relative to the first side Y-direction path 62a and a transport vehicle 20 traveling on the second side Y-direction path 62b toward the exit 33 on the first side X1 in the X-direction relative to the second side Y-direction path 62b travel on the auxiliary Y-direction path 63 between the first side Y-direction path 62a and the second side Y-direction path 62b. However, the disclosure is not limited to this structure. For example, a transport vehicle 20 traveling on the first side Y-direction path 62a toward the exit 33 on the second side X2 in the X-direction relative to the first side Y-direction path 62a may not travel on the auxiliary Y-direction path 63 between the first side Y-direction path 62a and the second side Y-direction path 62b. For example, a transport vehicle 20 traveling on the second side Y-direction path 62b toward the exit 33 on the first side X1 in the X-direction relative to the second side Y-direction path 62b may not travel on the auxiliary Y-direction path 63 between the first side Y-direction path 62a and the second side Y-direction path 62b.

(7) In the above embodiments, the auxiliary Y-direction path 63 is at a distance based on the distance K, expressed by Formula 1, from the first side Y-direction path 62a toward the second side X2 in the X-direction. However, the disclosure is not limited to this structure. For example, the position of the auxiliary Y-direction path 63 may be defined based on, for example, the frequency of congestion to have a longer distance from one of the first side Y-direction path 62a or the second side Y-direction path 62b on which the duration of congestion is longer (or on which the frequency of congestion is higher).

(8) In the above embodiments, the supply areas E1 are in the form of aisles extending in the Y-direction. However, the disclosure is not limited to this structure. For example, each supply area E1 may be planar and extend in the Y-direction and the X-direction, including one entrance 19.

(9) In the above embodiments, the receiving areas E3 are aisle areas extending in the Y-direction. However, the disclosure is not limited to this structure. For example, each receiving area E3 may be planar and extend in the Y-direction and the X-direction, including one receiver 31. For example, the receiving area E3 may include an aisle area and another area other than the aisle area.

(10) In the above embodiments, the floor E includes the first layer F1 and the second layer F2 adjacent to each other in the Z-direction. However, the disclosure is not limited to this structure. For example, the first layer F1 and the second layer F2 may not be adjacent to each other in the Z-direction. For example, the floor E may include three or more floors arranged in the Z-direction. For example, the second layer F2 may include the supply areas E1, the connection area E2, and the receiving areas E3, and the first layer F1 may include the back paths 44.

(11) In the above embodiments, the multiple exists 33 are each associated with a different one of the Y-direction paths 62. However, the disclosure is not limited to this structure. For example, the multiple exits 33 may be associated with the same Y-direction path 62. For example, the exits 33 and the Y-direction paths 62 may not be associated with one another.

(12) In the above embodiments, the entrances 19 in the supply areas E1 are aligned with the respective exits 33 in the receiving areas E3 as viewed in the Y-direction, and the connection area E2 connects the entrances 19 to the exits 33 to allow the transport vehicle 20 to travel between the areas. However, the disclosure is not limited to this structure. For example, the number of entrances 19 in the supply areas E1 may not be the same as the number of exits 33 in the receiving areas E3, and none of the entrances 19 may be aligned with an exit 33 as viewed in the Y-direction. For example, the connection areas E2 may connect the supply areas E1 to the receiving areas E3 not to allow travel of the transport vehicles 20 between the areas. The transport vehicles 20 may be transferred by a transfer device between the supply areas E1 and the receiving areas E3.

(13) In the above embodiments, the supply areas E1 and the connection area E2 are separated by the virtual boundaries, and the opposite ends in the X-direction of each receiving area E3 are the outer edges of the floor E. However, the disclosure is not limited to this structure. For example, the supply areas E1, the connection area E2, and the receiving areas E3 may be defined by the physical outer edges of the floor E and may each be an area in which the transport vehicles 20 are movable. For example, the supply areas E1, the connection area E2, and the receiving areas E3 may all be virtually defined areas on a large floor E. For example, the floor E may include areas different from the supply areas E 1, the connection area E2, and the receiving areas E3, such as buffer areas in which multiple transport vehicles 20 can be in line.

(14) In the above embodiments, the control system 45 includes the host controller that controls the multiple transport vehicles 20 and the controllers mounted on the respective transport vehicles 20. However, the disclosure is not limited to this structure. For example, the control system 45 may be a system in which the controller on each transport vehicle 20 communicates with the controller on another transport vehicle 20 to autonomously determine the operation. For example, the floor E may include no position information holder. Position information about the transport vehicles 20 may be obtained with, for example, image sensors installed in the transport vehicles 20 or the facility. For example, the article sorting facility 10 may not include the control system 45.

(15) In the above embodiments, the control system 45 controls the transferrer 21 and the traveler 25 in each transport vehicle 20. However, the disclosure is not limited to this structure. For example, the controller 46 may control only the traveler 25 in each transport vehicle 20. For example, each transport vehicle 20 may not include the transferrer 21, and the operating entity 16 may transfer the article W on the transport vehicle 20. The article W may be stored in a compartment included in the transport vehicle 20. The control system 45 may control an operation device, which is the operating entity 16.

(16) In the above embodiments, the article sorting facility 10 includes the supply transporters 17, the receiving transporters 35, and the shipping devices 36. However, the disclosure is not limited to this structure. For example, the article sorting facility 10 may not include the supply transporters 17, the receiving transporters 35, or the shipping devices 36. An operator or a vehicle operated by the operator may transport the articles W or the containers 38.

(17) In the above embodiments, the article sorting facility 10 includes the first lifters L1 and the second lifters L2. However, the disclosure is not limited to this structure. For example, the article sorting facility 10 may not include the first lifters L1. The transport vehicles 20 may be transported with, for example, a lifter or an aisle connecting the connection area E2 in the first layer F1 to the second layer F2. For example, the second lifters L2 may connect the connection area E2 in the first layer F1 to the aisle connection area E4 in the second layer F2.

(18) In the above embodiments, the back paths 44, the branching X-direction paths 51, the X-direction paths 52, the supply paths 61, the Y-direction paths 62, the auxiliary Y-direction path 63, the receiving outgoing paths 67, the receiving return paths 68, and the receiving paths 102 are one-way paths. However, the disclosure is not limited to this structure. For example, some or all of the back paths 44, the branching X-direction paths 51, the X-direction paths 52, the supply paths 61, the Y-direction paths 62, the auxiliary Y-direction path 63, the receiving outgoing paths 67, the receiving return paths 68, and the receiving paths 102 may be two-way paths.

(19) The structure described in each of the above embodiments may be combined with any other structures described in the other embodiments unless any contradiction arises. For other structures as well, the embodiments described herein are merely illustrative in all aspects. Thus, the embodiments described herein may be modified variously as appropriate without departing from the spirit and scope of the disclosure.

### Overview of Embodiments

Hereafter, the article sorting facility will be described.

An article sorting facility according to one or more embodiments of the disclosure is an article sorting facility in which a plurality of transport vehicles travel on a floor and transport articles to sort the articles. The article sorting facility includes a plurality of supply units that supply the articles to the plurality of transport vehicles and a plurality of receivers that receive the articles from the plurality of transport vehicles. The floor includes a connection area, a plurality of entrances, and a plurality of exits. The connection area extends in a Y-direction along the floor and in an X-direction perpendicular to the Y-direction along the floor. The plurality of entrances are arranged in the X-direction on a first side in the Y-direction of the connection area and are locations through which the plurality of transport vehicles supplied with the articles at the plurality of supply units enter the connection area. The plurality of exits are arranged in the X-direction on a second side in the Y-direction of the connection area and are locations through which the plurality of transport vehicles traveling toward the plurality of receivers exit the connection area. The connection area includes a plurality of Y-direction paths and a plurality of X-direction paths. The plurality of Y-direction paths are arranged in the X-direction, are as many as the plurality of entrances, and are paths on which the plurality of transport vehicles travel in the Y-direction. The plurality of X-direction paths are arranged in the Y-direction and are paths on which the plurality of transport vehicles travel in the X-direction. The floor includes an auxiliary Y-direction path in at least one of a plurality of Y-direction inter-path areas each between a pair of Y-direction paths, among the plurality of Y-direction paths, adjacent to each other in the X-direction. The auxiliary Y-direction path is a path on which the plurality of transport vehicles travel in the Y-direction. The auxiliary Y-direction path branches from at least one of the pair of Y-direction paths adjacent to each other in the X-direction.

In this structure, some of the transport vehicles that travel on at least one Y-direction path travel on the auxiliary Y-direction path. This reduces the number of transport vehicles that travel on the Y-direction path. The path on which a transport vehicle traveling from the Y-direction path travels in the X-direction before merging into the auxiliary Y-direction path can serve as a standby position at which the transport vehicle waits before merging into the auxiliary Y-direction path. This reduces congestion of transport vehicles traveling in the Y-direction, thus reducing the likelihood that the article transport efficiency of the transport vehicles decreases.

In one aspect, a distance in the X-direction between a pair of adjacent Y-direction paths of the plurality of Y-direction paths may be greater than a distance in the Y-direction between a pair of adjacent X-direction paths of the plurality of X-direction paths.

In this structure, when the distance in the X-direction between a pair of Y-direction paths adjacent to each other is greater than the distance in the Y-direction between a pair of X-direction paths adjacent to each other, the distance between intersections between the multiple X-direction paths on a Y-direction path is less than the distance between intersections between the multiple Y-direction paths on an X-direction path, causing congestion more frequently on the Y-direction paths than on the X-direction paths. As described above, the technique according to one or more embodiments of the disclosure reduces congestion of the transport vehicles traveling in the Y-direction. Thus, the technique according to one or more embodiments of the disclosure may be applicable when the distance in the X-direction between a pair of Y-direction paths adjacent to each other is greater than the distance in the Y-direction between a pair of X-direction paths adjacent to each other.

In one aspect, the plurality of Y-direction paths may include a first side Y-direction path being adjacent to the auxiliary Y-direction path on a first side in the X-direction. A transport vehicle of the plurality of transport vehicles traveling on the first side Y-direction path toward an exit, among the plurality of exits, on a second side in the X-direction relative to the first side Y-direction path may travel on the auxiliary Y-direction path.

In this structure, after a transport vehicle moves to the second side in the X-direction and travels on the auxiliary Y-direction path, the transport vehicle does not return to the first side in the X-direction. This structure can avoid an unintendedly long travel distance of the transport vehicle and an unintended increase in the number of transport vehicles traveling on the path intersecting with the first side Y-direction path. The structure thus easily increases the article transport efficiency of the transport vehicles.

In one aspect, the connection area may include a branching X-direction path on which a transport vehicle of the plurality of transport vehicles traveling from a Y-direction path of the plurality of Y-direction paths travels in the X-direction before entering the auxiliary Y-direction path, the branching X-direction path being on the first side in the Y-direction relative to the plurality of X-direction paths.

In this structure, the number of transport vehicles waiting to pass through the entrances can be reduced. The structure thus easily increases the article transport efficiency of the transport vehicles.

In one aspect, each of the plurality of entrances may be associated with a corresponding X-direction path of the plurality of X-direction paths as an X-direction corresponding path. When a transport vehicle of the plurality of transport vehicles entering the connection area through an entrance of the plurality of entrances travels in the X-direction, the transport vehicle may turn toward a first side or a second side in the X-direction on the X-direction corresponding path associated with the entrance to travel on the X-direction corresponding path. A transport vehicle of the plurality of transport vehicles may travel on the auxiliary Y-direction path when entering the connection area through an entrance, among the plurality of entrances, associated with the X-direction corresponding path being an X-direction path farthest on the second side in the Y-direction.

In this structure, the X-direction corresponding path farthest from the entrance causes many intersections to be passed before the X-direction corresponding path is reached and causes congestion more frequently on the Y-direction paths. The auxiliary Y-direction paths reduce the number of transport vehicles traveling on such Y-direction paths, reducing the congestion of transport vehicles traveling in the Y-direction. The structure thus easily increases the article transport efficiency of the transport vehicles.

In one aspect, each pair of entrances adjacent to each other in the X-direction, among the plurality of entrances, may be associated with a corresponding X-direction path of the plurality of X-direction paths as an X-direction corresponding path. When a transport vehicle of the plurality of transport vehicles entering the connection area through an entrance of the plurality of entrances travels in the X-direction, the transport vehicle may turn toward a first side or a second side in the X-direction on the X-direction corresponding path associated with the entrance to travel on the X-direction corresponding path. The auxiliary Y-direction path may be disposed in the Y-direction inter-path area between Y-direction paths, among the plurality of Y-direction paths, each associated with a corresponding entrance of each pair of entrances associated with the corresponding X-direction corresponding path. The Y-direction paths each associated with the corresponding entrance of each pair of entrances may include a first side Y-direction path adjacent to the auxiliary Y-direction path on the first side in the X-direction and a second side Y-direction path adjacent to the auxiliary Y-direction path on the second side in the X-direction. A transport vehicle of the plurality of transport vehicles traveling on the first side Y-direction path toward an exit, among the plurality of exits, on the second side in the X-direction relative to the first side Y-direction path may travel on the X-direction corresponding path toward the second side in the X-direction after traveling on the auxiliary Y-direction path. A transport vehicle of the plurality of transport vehicles traveling on the second side Y-direction path toward an exit, among the plurality of exits, on the first side in the X-direction relative to the second side Y-direction path may travel on the X-direction corresponding path toward the first side in the X-direction after traveling on the auxiliary Y-direction path.

In this structure, the transport vehicles do not return to the first side in the X-direction after moving to the second side in the X-direction and traveling on the auxiliary Y-direction paths, or the transport vehicles do not return to the second side in the X-direction after moving to the first side in the X-direction and traveling on the auxiliary Y-direction paths. This structure avoids an unintendedly long travel distance of the transport vehicles and an unintended increase in the number of transport vehicles traveling on the path intersecting with the first side Y-direction path and the second side Y-direction path. The structure thus easily increases the article transport efficiency of the transport vehicles.

In one aspect, the plurality of exits may be N exits, where N is a natural number greater than or equal to 2. An exit, among the N exits, corresponding to the first side Y-direction path may be an M-th exit from the first side in the X-direction. An exit, among the N exits, corresponding to the second side Y-direction path may be an (M+1)th exit from the first side in the X-direction. The auxiliary Y-direction path may be at a distance based on a distance K=D1×{(N−M)/N} from the first side Y-direction path toward the second side in the X-direction, where D1 is a dimension in the X-direction of the Y-direction inter-path area between the first side Y-direction path and the second side Y-direction path.

In this structure, when the destinations of the transport vehicles entering the connection area through the respective entrances are evenly allocated among N exits, the ratio of the distance in the X-direction from the first side Y-direction path to the auxiliary Y-direction path to the distance in the X-direction from the second side Y-direction path to the auxiliary Y-direction path is set based on the ratio of the number of transport vehicles that enter the first side Y-direction path and branch into the auxiliary Y-direction path to the number of transport vehicles that enter the second side Y-direction path and branch into the auxiliary Y-direction path. Thus, the frequency of congestion of the transport vehicles at the entrance of the auxiliary Y-direction path is less likely to be uneven between the first side Y-direction path and the second side Y-direction path. This reduces congestion of the transport vehicles, thus increasing the article transport efficiency of the transport vehicles.

What is claimed is:

1. An article sorting facility in which a plurality of transport vehicles travel on a floor and transport articles to sort the articles, the article sorting facility comprising:
a plurality of supply units configured to supply the articles to the plurality of transport vehicles; and
a plurality of receivers configured to receive the articles from the plurality of transport vehicles;
wherein the floor comprises:
a connection area extending in a Y-direction along the floor and in an X-direction along the floor, the X-direction being perpendicular to the Y-direction,
a plurality of entrances arranged in the X-direction on a first side in the Y-direction of the connection area, the plurality of entrances comprising locations through which the plurality of transport vehicles supplied with the articles at the plurality of supply units enter the connection area, and
a plurality of exits arranged in the X-direction on a second side in the Y-direction of the connection area, the plurality of exits comprising locations through which the plurality of transport vehicles traveling toward the plurality of receivers exit the connection area,
wherein the connection area comprises:
a plurality of Y-direction paths arranged in the X-direction, the plurality of Y-direction paths being as many as the plurality of entrances, the plurality of Y-direction paths comprising paths on which the plurality of transport vehicles travel in the Y-direction, and
a plurality of X-direction paths arranged in the Y-direction, the plurality of X-direction paths comprising paths on which the plurality of transport vehicles travel in the X-direction, and
wherein the floor comprises an auxiliary Y-direction path in at least one of a plurality of Y-direction inter-path areas each between a pair of Y-direction paths, among the plurality of Y-direction paths, adjacent to each other in the X-direction, the auxiliary Y-direction path comprising a path on which the plurality of transport vehicles travel in the Y-direction, the auxiliary Y-direction path branching from at least one of the pair of Y-direction paths adjacent to each other in the X-direction.

2. The article sorting facility according to claim 1, wherein:
a distance in the X-direction between a pair of adjacent Y-direction paths of the plurality of Y-direction paths is greater than a distance in the Y-direction between a pair of adjacent X-direction paths of the plurality of X-direction paths.

3. The article sorting facility according to claim 1, wherein:
the plurality of Y-direction paths comprise a first side Y-direction path adjacent to the auxiliary Y-direction path on a first side in the X-direction, and
a transport vehicle of the plurality of transport vehicles traveling on the first side Y-direction path toward an exit, among the plurality of exits, on a second side in the X-direction relative to the first side Y-direction path travels on the auxiliary Y-direction path.

4. The article sorting facility according to claim 1, wherein:
the connection area comprises a branching X-direction path on which a transport vehicle of the plurality of transport vehicles traveling from a Y-direction path of the plurality of Y-direction paths travels in the X-direction before entering the auxiliary Y-direction path, the branching X-direction path being on the first side in the Y-direction relative to the plurality of X-direction paths.

5. The article sorting facility according to claim 1, wherein:
each of the plurality of entrances is associated with a corresponding X-direction path of the plurality of X-direction paths as an X-direction corresponding path,
when a transport vehicle of the plurality of transport vehicles entering the connection area through an entrance of the plurality of entrances travels in the X-direction, the transport vehicle turns toward a first side or a second side in the X-direction on the X-direction corresponding path associated with the entrance to travel on the X-direction corresponding path, and
a transport vehicle of the plurality of transport vehicles travels on the auxiliary Y-direction path when entering the connection area through an entrance, among the plurality of entrances, associated with the X-direction corresponding path being an X-direction path farthest on the second side in the Y-direction.

6. The article sorting facility according to claim 1, wherein:
each pair of entrances adjacent to each other in the X-direction, among the plurality of entrances, is associated with a corresponding X-direction path of the plurality of X-direction paths as an X-direction corresponding path,
when a transport vehicle of the plurality of transport vehicles entering the connection area through an entrance of the plurality of entrances travels in the X-direction, the transport vehicle turns toward a first side or a second side in the X-direction on the X-direction corresponding path associated with the entrance to travel on the X-direction corresponding path,
the auxiliary Y-direction path is disposed in the Y-direction inter-path area between Y-direction paths, among the plurality of Y-direction paths, each associated with a corresponding entrance of each pair of entrances associated with the corresponding X-direction corresponding path,
the Y-direction paths each associated with the corresponding entrance of each pair of entrances comprise a first side Y-direction path adjacent to the auxiliary Y-direction path on the first side in the X-direction and a second side Y-direction path adjacent to the auxiliary Y-direction path on the second side in the X-direction,
a transport vehicle of the plurality of transport vehicles traveling on the first side Y-direction path toward an exit, among the plurality of exits, on the second side in the X-direction relative to the first side Y-direction path travels on the X-direction corresponding path toward the second side in the X-direction after traveling on the auxiliary Y-direction path, and
a transport vehicle of the plurality of transport vehicles traveling on the second side Y-direction path toward an exit, among the plurality of exits, on the first side in the X-direction relative to the second side Y-direction path travels on the X-direction corresponding path toward the first side in the X-direction after traveling on the auxiliary Y-direction path.

7. The article sorting facility according to claim 6, wherein:
the plurality of exits are N exits, where N is a natural number greater than or equal to 2,
an exit, among the N exits, corresponding to the first side Y-direction path is an M-th exit from the first side in the X-direction,
an exit, among the N exits, corresponding to the second side Y-direction path is an (M+1)th exit from the first side in the X-direction, and
the auxiliary Y-direction path is at a distance based on a distance K=D1×{(N−M)/N} from the first side Y-direction path toward the second side in the X-direction, where D1 is a dimension in the X-direction of the Y-direction inter-path area between the first side Y-direction path and the second side Y-direction path.
